(19) United States
(12) Patent Application Publication
(10) Pub. No.: US 2015/0353060 A1
(43) Pub. Date: Dec. 10, 2015

(54) LATERAL MOVEMENT ASSISTANCE APPARATUS FOR A VEHICLE

(71) Applicant: Xing-Han CHEN, Taichung City (TW)

(72) Inventor: Xing-Han CHEN, Taichung City (TW)

(21) Appl. No.: 14/297,299

(22) Filed: Jun. 5, 2014

(51) Int. Cl. B60S 9/21

(52) U.S. Cl. CPC B60S 9/21

(57) ABSTRACT

A lateral movement assistance apparatus for a vehicle includes a driving unit and a lifting device. The driving unit includes an extending sleeve, a sleeve holder, a driving shaft, a rotary plate and a driving gear. The lifting device is connected with and driven by the driving unit and includes a fixing plate, two connecting plates, a hydraulic pump, a moveable bar, a transmission unit and a wheel unit. The apparatus can be installed in a shock absorber and a wheel of a vehicle to assist lateral parking on the street and substitutes for a hoisting jack to lift the vehicle up in case of flat tire or when the car is stuck in a hole, etc.

### BACKGROUND OF THE INVENTION

1. Field of the Invention

The present invention relates to a vehicle and more particularly to a lateral movement assistance apparatus for a vehicle.

2. Description of Related Art

Car parking is a big problem for drivers with disabilities or for greenhorn drivers. These drivers take more time in car parking than other drivers and often feel frustrated.

Multiple types of car parking assistance apparatus are invented to solve the parking problem. However, these car parking assistance apparatus have some common problems such as complicated structures or difficulty in installation.

To overcome the shortcomings of the conventional car parking assistance apparatus, the present invention provides a lateral movement assistance apparatus for a vehicle to mitigate or obviate the aforementioned problems.

### SUMMARY OF THE INVENTION

The main objective of the invention is to provide a lateral movement assistance apparatus for a vehicle. The lateral movement assistance apparatus includes a driving unit and a lifting device.

The driving unit includes an extending sleeve, a sleeve holder, a driving shaft, a rotary plate and a driving gear. The lifting device is connected with and driven by the driving unit and includes a fixing plate, two connecting plates, a hydraulic pump, a moveable bar, a transmission unit, and a wheel unit.

Other objects, advantages, and novel features of the invention will become more apparent from the following detailed description when taken in conjunction with the accompanying drawing.

### BRIEF DESCRIPTION OF THE DRAWINGS

FIG. 1 is a perspective view of a lateral movement assistance apparatus in accordance with the present invention;

FIG. 2 is another perspective view of the lateral movement assistance apparatus in FIG. 1;

FIG. 3 is a perspective view of a transmission unit of the lateral movement assistance apparatus in FIG. 1;

FIG. 4 is a front view of the lateral movement assistance apparatus in FIG. 1.

FIG. 5 is an operational front view of the lateral movement assistance apparatus in FIG. 4;

FIG. 6 is a schematic view showing parking a vehicle installed with the lateral movement assistance apparatus on the street;

FIG. 7 is another schematic view showing parking a vehicle installed with the lateral movement assistance apparatus on the street;

FIG. 8 is a schematic view showing a vehicle installed with the lateral movement assistance apparatus taking U-turn on the street;

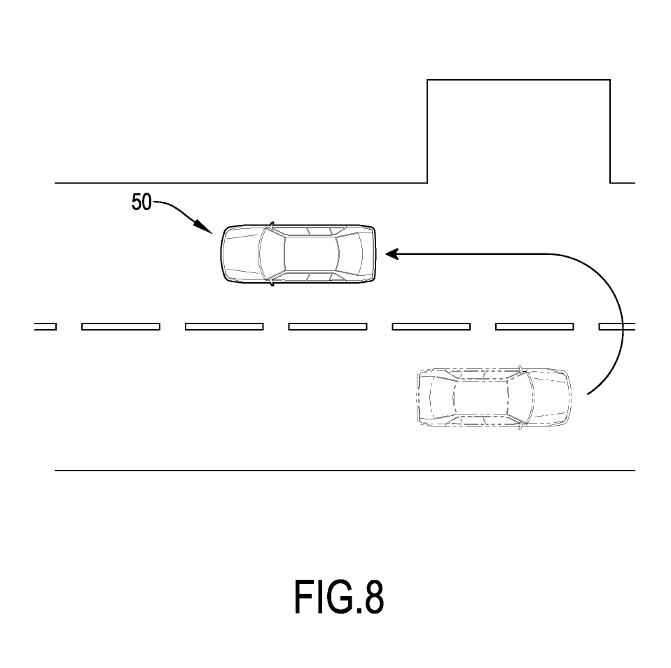

FIG. 9 is a schematic view showing driving a vehicle installed with the lateral movement assistance apparatus in a garage;

FIG. 10 is a perspective view of a second embodiment of a lateral movement assistance apparatus in accordance with the present invention;

FIG. 11 is a front view of the lateral movement assistance apparatus in FIG. 10; and

FIG. 12 is an operational front view of the lateral movement assistance apparatus in FIG. 11.

### DETAILED DESCRIPTION OF PREFERRED EMBODIMENT

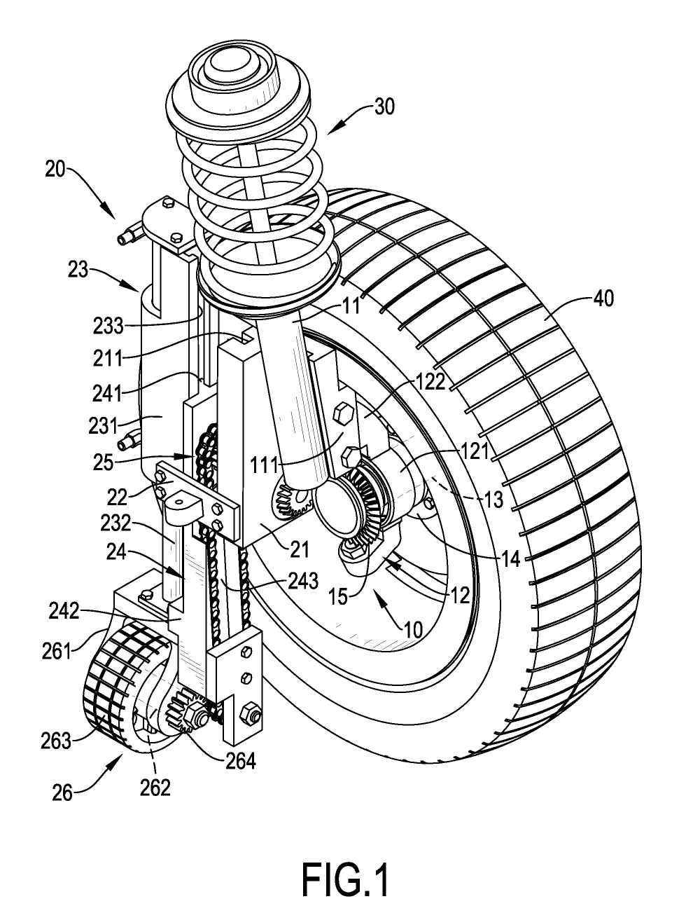

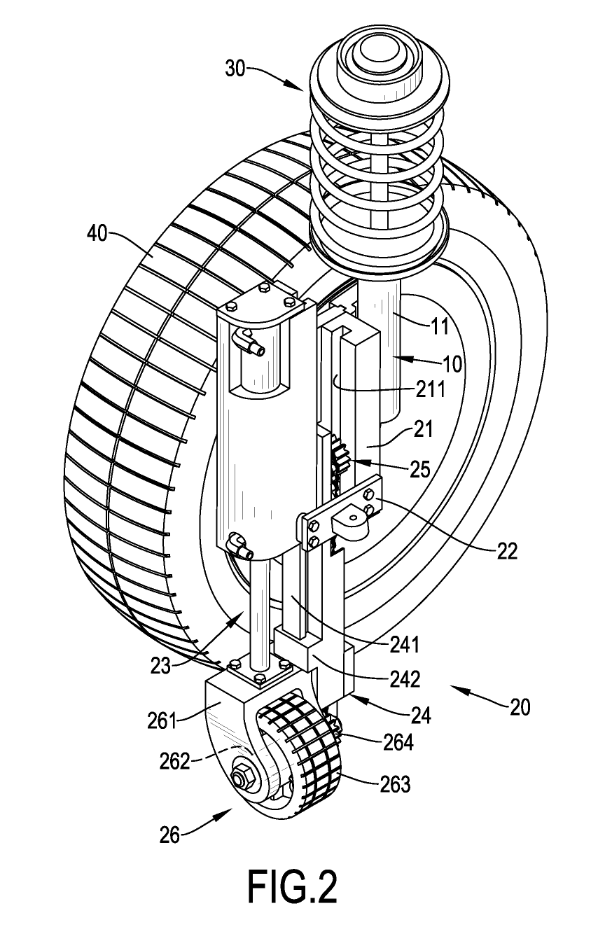

With reference to FIGS. 1 and 2, a first embodiment of a lateral movement assistance apparatus includes a driving unit 10 and a lifting device 20.

The driving unit 10 may be installed on a shock absorber 30 and a wheel 40 of a vehicle and includes an extending sleeve 11, a sleeve holder 12, a driving shaft 13, a rotary plate 14 and a driving gear 15. The extending sleeve 11 is elongated, is mounted at a bottom end of the shock absorber 30, and has an outer surface and a connecting seat 111 mounted on the outer surface. The sleeve holder 12 is mounted on the connecting seat 111 of the extending sleeve 11 and has a ring portion 121 and multiple clutches 122. The clutches 122 are mounted around the ring portion 121 at intervals. One of the clutches 122 is connected with the connecting seat 111. The driving shaft 13 is inserted in the ring portion 121 and has a front end and a rear end. The front and rear ends of the driving shaft 13 protrude out from two sides of the ring portion 121. The rotary plate 14 is mounted on the rear end of the driving shaft 13 and is connected with the wheel 40. The driving gear 15 is a helical gear and is mounted on the front end of the driving shaft 13.When the wheel 40 rotates, the driving shaft 13, the rotary plate 14 and the driving gear 15 are rotated synchronously.

The lifting device 20 is connected with the driving unit 10, is driven by the driving unit 10, and includes a fixing plate 21, two connecting plates 22, a hydraulic pump 23, a moveable bar 24, a transmission unit 25, and a wheel unit 26.

The fixing plate 21 is rectangular in cross section, is connected with the connecting seat 111 and has a right side, a left side, a front side, a rear side, and a sliding groove 211. The sliding groove 211 is formed in the left side of the fixing plate 21.The connecting plates 22 are respectively mounted on the front side and the rear side of the fixing plate 21.

The hydraulic pump 23 is parallel to the fixing plate 21, is connected with the connecting plates 22, and has a barrel 231, a piston rod 232 and a sliding recess 233. The barrel 231 is connected with the connecting plates 22 and has a moving space surrounded by the barrel 231, the connecting plates 22 and the fixing plate 21.The piston rod 232 is telescopically mounted in the barrel 231. The sliding recess 233 is T-shaped in cross section, is formed in one side of the barrel 231, and is aligned with the sliding groove 211 of the fixing plate 21.

The moveable bar 24 is slidably mounted in the moving space, is connected with the barrel 231 and has a left face, a right face, a sliding bar 241, a stop block 242, and a roller chain recess 243. The sliding bar 241 and the stop block 242 are formed on the left face, and the roller chain recess 243 is formed in the right face. The sliding bar 241 is T-shaped in cross section and is mounted in the sliding recess 233 of the hydraulic pump 23. The stop block 242 is located under the sliding bar 241 and protrudes toward the hydraulic pump 23.

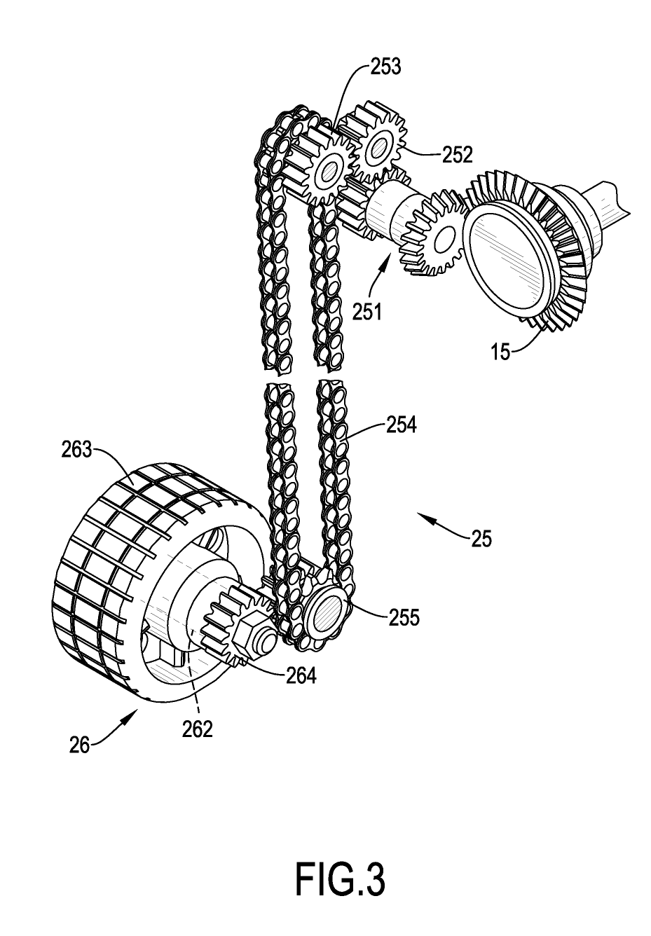

With reference to FIGS. 1, 2 and 3, the transmission unit 25 is mounted on the fixing plate 21 and the moveable bar 24 and includes an input gear 251, a first connecting gear 252, a second connecting gear 253, a roller chain 254 and an output gear 255. The input gear 251 is mounted through the fixing plate 21 and has a helical gear end and a spur gear end, and the helical gear end of the input gear 251 is engaged with the driving gear 15. The first connecting gear 252, the second connecting gear 253, and the output gear 255 are mounted on the moveable bar 24. The first connecting gear 252 is a spur gear, is located above the input gear 251, and is engaged with the spur gear end of the input gear 251. The second connecting gear 253 and the output gear 255 are respectively located at an upper position and a lower position of the moveable bar 24 and extend respectively in opposite directions, and respectively have a sprocket end and a gear end. The gear end of the second connecting gear 253 is engaged with the first connecting gear 252. The roller chain 254 is mounted around the sprocket ends of the second connecting gear 253 and the output gear 255.

When the input gear 251 serves as an input end and is driven by the driving gear 15, the first connecting gear 252 and the second connecting gear 253 are rotated synchronously. Then the second connecting gear 253 moves the roller chain 254 to rotate the output gear 255. The output gear 255 serves as an output end to transfer the input power.

The wheel unit 26 is mounted on the piston rod 232, is connected with the output gear 255, is driven by the transmission unit 25, and includes a wheel seat 261, a driving shaft 262, an assistance wheel 263 and a wheel gear 264. The wheel seat 261 is mounted on a bottom of the piston rod 232. The driving shaft 262 is mounted through the wheel seat 261 and has a protruding end protruding out of the wheel seat 261. The assistance wheel 263 is fixed on the driving shaft 262. The wheel gear 264 is fixed on the protruding end of the driving shaft 262 and is engaged with the output gear 255. When the transmission unit 25 is operating, the assistance wheel 263 is rotated by the output gear 255 and the wheel gear 264.

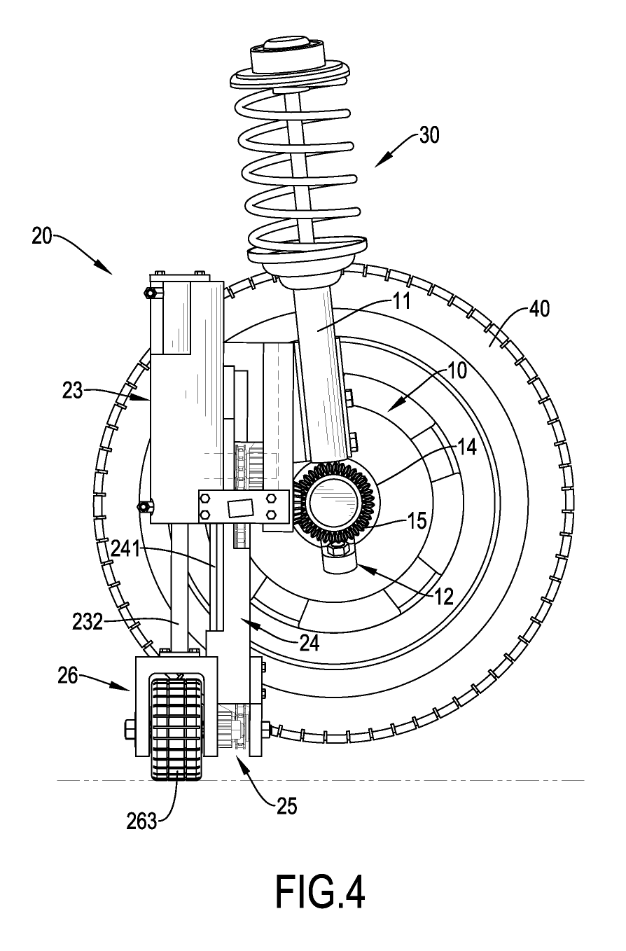

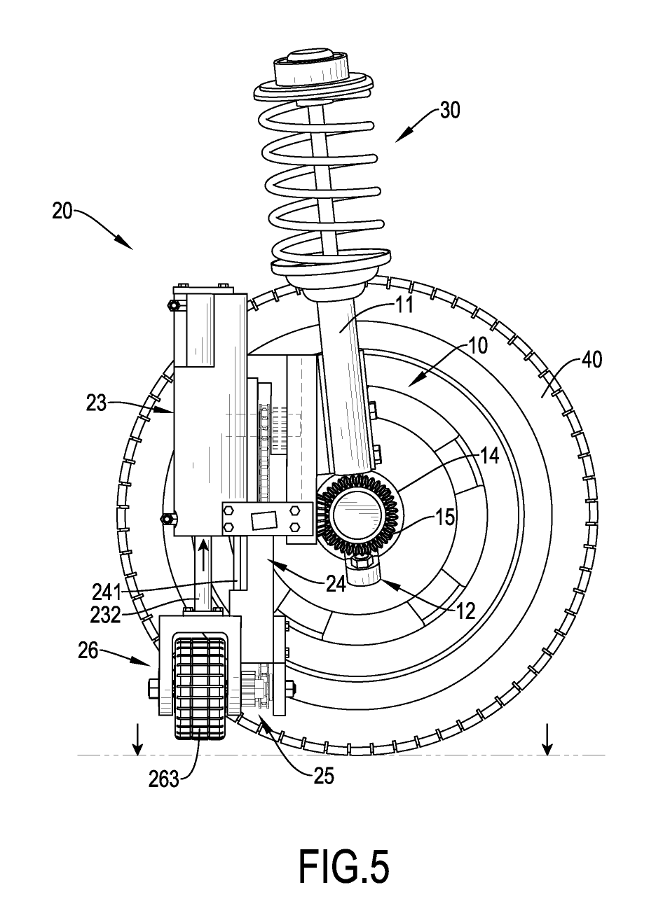

With reference to FIGS. 4 and 5, the assistance apparatus can be easily installed on or removed from each shock absorber 30 and wheel 40 of a vehicle. The type of vehicle can be 2WD or 4WD. When the piston rod 232 extends, the assistance wheel 263 can contact the ground and the wheel unit 26 props on the ground and lifts the vehicle up from the ground. When the vehicle is stuck in a hole or a ditch, or has a flat tire, the lifting device 20 can substitute for a hoisting jack to pull up the vehicle from the hole or the ditch or replace the flat tire.

When the wheel 40 rotates, the rotary plate 14 and the driving gear 15 are rotated by the wheel 40, and then the transmission unit 25 is driven by the driving gear 15. Meanwhile, the wheel unit 26 is also rotated by the transmission unit 25. Therefore, the vehicle can be moved laterally by the wheel unit 26. When the wheel 40 rotates forward or rearward, the vehicle moves toward the right or the left. Additional, if the vehicle is 4WD, the front wheels and the rear wheels can rotate toward different direction that makes the vehicle rotating in situ.

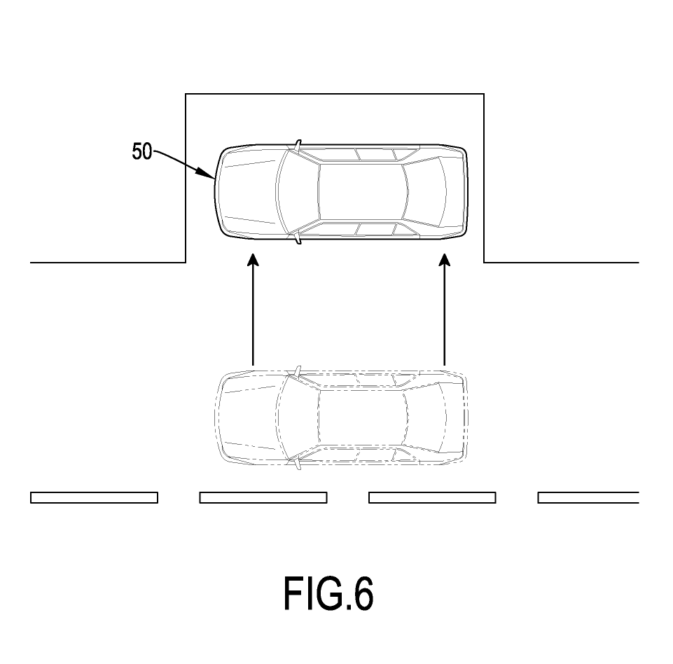

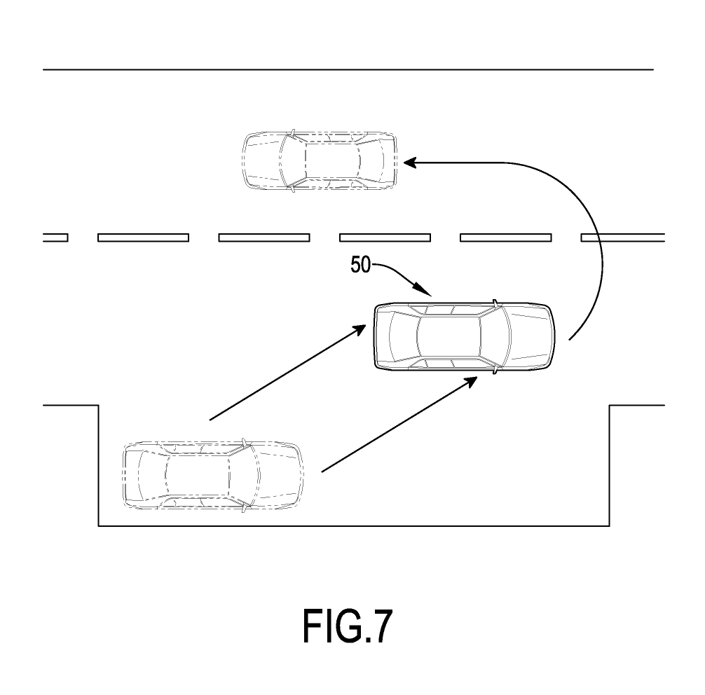

With reference to FIGS. 5, 6 and 7, when less-skilled drivers want to park a vehicle 50 on the street, they can drive the vehicle beside or adjacent the parking space and turn on the lifting device 20 to pull up the vehicle and uses the assistance wheel 263, and then the vehicle can laterally or obliquely move into the parking space to easily and quickly accomplish parking.

With the reference to FIGS. 5,7 and 8, when the drivers want to take a U-turn on the street, they just need to turn on the lifting device 20 and operates the steering wheel of the vehicle 50. The vehicle 50 can take a quick U-turn with a minor radius of gyration.

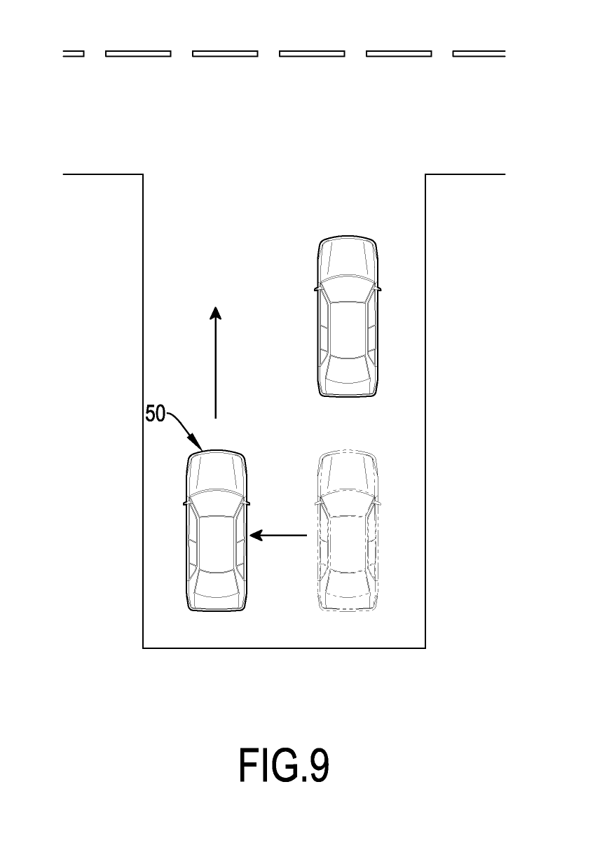

With the reference to FIG. 9, when the driver wants to drive his car out of the garage and another car is blocking behind the driver's car, the driver can laterally move his car from the garage and drives his car out garage without trouble.

After using the lifting device 20, the piston rod 232 is retracted, the moveable bar 24 moves up and separates the transmission unit 25 from the driving gear 15, and then the wheel unit 26 stops working. Therefore, the wheel 40 can be resumed in normal operation.

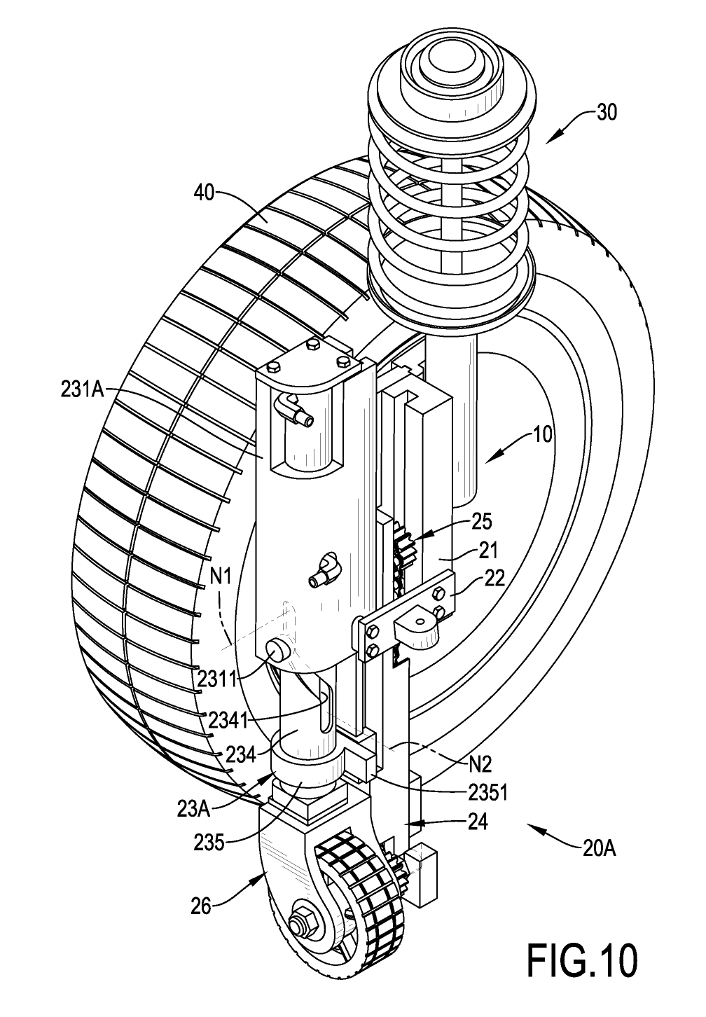

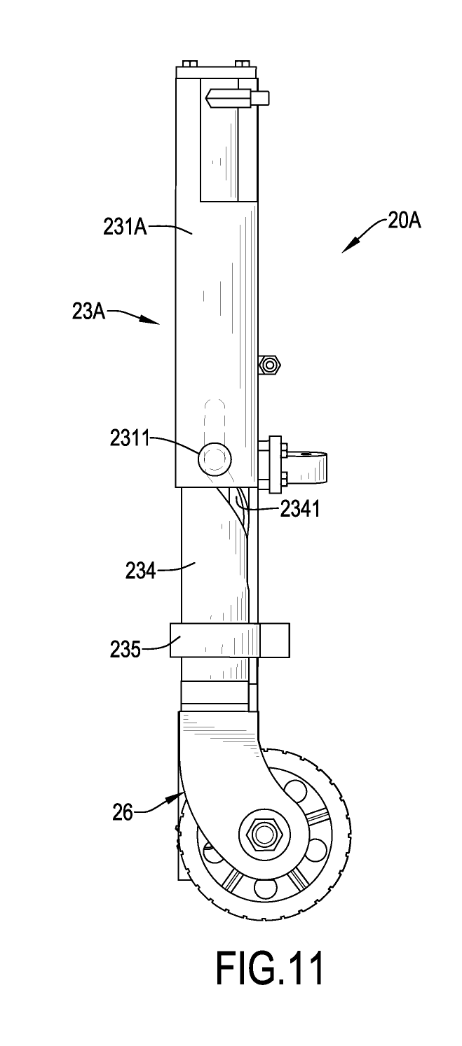

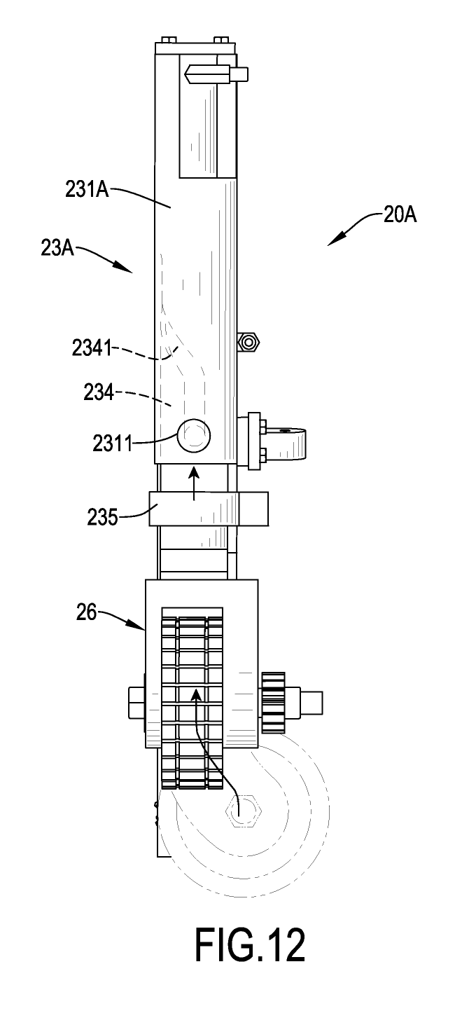

With reference to FIGS. 10 to 12, in a second embodiment of a lateral movement assistance apparatus in accordance with the present invention, the elements and effects of the second embodiment are same as those of the first embodiment except for the hydraulic pump 23A of the lifting device 20A.

The hydraulic pump 23A further includes a cylinder 234 and a blocking ring 235. The barrel 231A further includes a guiding rod 2311 mounted through the barrel 231A. The cylinder 234 and the blocking ring 235 are mounted around the piston rod 232. The cylinder 234 has an outer surface and a sliding slot 2341 formed in the outer surface of the cylinder 234. The sliding slot 2341 has two longitudinal sections and a curved section connected with the longitudinal sections, and each longitudinal section has a normal line N1, N2. When the normal line N1 is projected downward and the normal line N2 is projected upward, the longitudinal projections of the normal lines N1, N2 are crossed and form a right angle. The curved section is sloped. The guiding rod 2311 extends into the sliding slot 2341. The blocking ring 235 is located between the cylinder 234 and the wheel unit 26 and has a protrusion 2351 abutting against the moveable bar 24.

When the hydraulic pump 23A of the lifting device 20A is operating, the piston rod 232 and the cylinder 234 are extended or retracted. Because the sliding slot 2341 is guided by the guiding rod 2311, the cylinder 234 is rotated along an axis of the cylinder 234 such that the wheel unit 26 can be rotated in a direction parallel to the wheel 40.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lateral movement assistance apparatus comprising:
a driving unit including
an extending sleeve mounted on a shock absorber and having an outer surface and a connecting seat formed on the outer surface;
a sleeve holder mounted on the connecting seat and having a ring portion and multiple clutches, one of the clutches connected with the connecting seat;
a driving shaft inserted in the ring portion and having a front end and a rear end, the front and rear ends of the driving shaft protruding from two sides of the ring portion;
a rotary plate mounted on the rear end of the driving shaft and connected with a wheel; and
a driving gear mounted on the front end of the driving shaft;
a lifting device connected with and driven by the driving unit and including
a fixing plate connected with the connecting seat of the extending sleeve;
two connecting plates respectively mounted on two sides of the fixing plate;
a hydraulic pump connected with the connecting plates and including
a barrel being parallel to the fixing plate and connected with the connecting plates and forming a moving space surrounded by the barrel, the connecting plates and the fixing plate;
a piston rod telescopically mounted in the barrel;
a moveable bar slidably mounted in the moving space and connected with the barrel;
a transmission unit mounted on the fixing plate and the moveable bar and including an input end and an output end, the input end of the transmission unit connected with the driving gear; and
a wheel unit mounted on the piston rod and driven by the transmission unit and including
a wheel seat mounted on the piston rod;
a driving shaft mounted through the wheel seat and having a protruding end protruding out of the wheel seat;
an assistance wheel fixed on the driving shaft; and
a wheel gear fixed on the protruding end of the driving shaft and connected with the output end of the transmission unit.

2. The lateral movement assistance apparatus as claimed in claim 1, wherein the transmission unit includes
an input gear serving as the input end and mounted through the fixing plate and engaged with the driving gear;
a first connecting gear mounted on the moveable bar and engaged with the input gear;
a second connecting gear mounted on the moveable bar and engaged with the first connecting gear side by side;
an output gear serving as the output end and mounted on the moveable bar and located under the second connecting gear; and
a roller chain connected with the second connecting gear and the output gear.

3. The lateral movement assistance apparatus as claimed in claim 2, wherein the driving gear is a helical gear, the input gear has a helical gear end and a spur gear end, and the helical gear end of the input gear is engaged with the driving gear.

4. The lateral movement assistance apparatus as claimed in claim 3, wherein the second connecting gear and the output gear both have a sprocket end and a gear end, the gear end of the second connecting gear is engaged with the first connecting gear; the roller chain is mounted on the sprocket end of the second connecting gear and the sprocket end of the output gear.

5. The lateral movement assistance apparatus as claimed in claim 1, wherein the fixing plate has a sliding groove, the hydraulic pump has a sliding recess aligning with the sliding groove; and the moveable bar has a sliding bar mounted in the sliding recess.

6. The lateral movement assistance apparatus as claimed in claim 2, wherein the fixing plate has a sliding groove, the hydraulic pump has a sliding recess aligning with the sliding groove; and the moveable bar has a sliding bar mounted in the sliding recess.

7. The lateral movement assistance apparatus as claimed in claim 3, wherein the fixing plate has a sliding groove, the hydraulic pump has a sliding recess aligning with the sliding groove; and the moveable bar has a sliding bar mounted in the sliding recess.

8. The lateral movement assistance apparatus as claimed in claim 4, wherein the fixing plate has a sliding groove, the hydraulic pump has a sliding recess aligning with the sliding groove; and the moveable bar has a sliding bar mounted in the sliding recess.

9. The lateral movement assistance apparatus as claimed in claim 5, wherein the hydraulic pump further includes a cylinder, the cylinder has an outer surface and a sliding slot formed on the outer surface of the cylinder, and the barrel further includes a guiding rod mounted through the barrel and extending into the sliding slot.

10. The lateral movement assistance apparatus as claimed in claim 6, wherein the hydraulic pump further includes a cylinder, the cylinder has an outer surface and a sliding slot formed on the outer surface of the cylinder, and the barrel further includes a guiding rod mounted through the barrel and extending into the sliding slot.

11. The lateral movement assistance apparatus as claimed in claim 7, wherein the hydraulic pump further includes a cylinder, the cylinder has an outer surface and a sliding slot formed on the outer surface of the cylinder, and the barrel further includes a guiding rod mounted through the barrel and extending into the sliding slot.

12. The lateral movement assistance apparatus as claimed in claim 8, wherein the hydraulic pump further includes a cylinder, the cylinder has an outer surface and a sliding slot formed on the outer surface of the cylinder, and the barrel further includes a guiding rod mounted through the barrel and extending into the sliding slot.

13. The lateral movement assistance apparatus as claimed in claim 9, wherein the sliding slot has two longitudinal sections and a curved section connected with the longitudinal sections, each longitudinal section has a normal line, longitudinal projections of the normal lines are crossed and form a right angle; the curved section is sloped.

14. The lateral movement assistance apparatus as claimed in claim 10, wherein the sliding slot has two longitudinal sections and a curved section connected with the longitudinal sections, each longitudinal section has a normal line, longitudinal projections of the normal lines are crossed and form a right angle; the curved section is sloped.

15. The lateral movement assistance apparatus as claimed in claim 11, wherein the sliding slot has two longitudinal sections and a curved section connected with the longitudinal sections, each longitudinal section has a normal line, longitudinal projections of the normal lines are crossed and form a right angle; the curved section is sloped.

16. The lateral movement assistance apparatus as claimed in claim 12, wherein the sliding slot has two longitudinal sections and a curved section connected with the longitudinal sections, each longitudinal section has a normal line, longitudinal projections of the normal lines are crossed and form a right angle; the curved section is sloped.
